(19) United States
(12) Patent Application Publication
(10) Pub. No.: US 2014/0293024 A1
(43) Pub. Date: Oct. 2, 2014

(54) FOLDABLE DISPLAY AND METHOD AND APPARATUS FOR CONTROLLING THE SAME

(71) Applicant: Samsung Display Co., Ltd., Yongin-City (KR)

(72) Inventors: Byeong-Hwa Choi, Yongin-city (KR); Seung-Bae Lee, Yongin-city (KR)

(73) Assignee: Samsung Display Co., Ltd., Yongin-City (KR)

(21) Appl. No.: 14/011,595

(22) Filed: Aug. 27, 2013

(30) Foreign Application Priority Data
Apr. 1, 2013 (KR) 10-2013-0035460

(51) Int. Cl. H04N 13/04; G06F 1/16

(52) U.S. Cl. CPC H04N 13/0409; G06F 1/1601
USPC 348/54; 361/679.21

(57) ABSTRACT

A foldable display and a method and apparatus for controlling the foldable display are disclosed. In one aspect, the apparatus includes a display device including a first display panel and a second display panel disposed on the first display panel, wherein the first and second display panels are folded along a first axis. The apparatus also includes a recognizer for recognizing folding of at least one of the first and second display panels and a display controller for controlling a display operation of the display device according to the recognized folding.

### CROSS-REFERENCE TO RELATED APPLICATION

This application claims the benefit of Korean Patent Application No. 10-2013-0035460, filed on Apr. 1, 2013, in the Korean Intellectual Property Office, the disclosure of which is incorporated herein in its entirety by reference.

### BACKGROUND

1. Field

The disclosed technology relates to a foldable display and a method and apparatus for controlling the same, and more particularly, to a foldable display for displaying a stereoscopic image and a method and apparatus for controlling the same.

2. Description of the Related Technology

Research and development is being actively carried out regarding displays for providing three-dimensional (3D) images. Since human eyes are horizontally separated from each other by an average distance of about 65 mm, left and right eyes look at an object from different points of view so that the eyes view different images. This binocular disparity provided by two eyes allows a viewer to perceive depth of objects. Thus, a left-eye-image and a right-eye-image separated by binocular disparity are seen by the viewer's two eyes, respectively, and are combined to produce a 3D image.

Currently commercially available 3D image displays use a binocular parallax between the two eyes to provide a left-eye image and a right-eye image having different viewpoints to the left and right eyes of a viewer, respectively, thereby allowing a viewer to receive a stereoscopic effect.

Two common methods for producing a 3D image using an image displayed on a display are time division schemes and spatial division schemes. The time division scheme uses eye glasses worn by a user to alternately display a left-eye-view and a right-eye-view so that the two views are separately rendered for the corresponding eyes. The spatial division scheme is an approach in which both a left-eye-view and a right-eye-view are displayed within one frame. Generally, a polarizing film is used to separate the two views from each other.

Another approach, not requiring eyewear, is to refract left and right images through a lenticular screen of a display unit including an array of lenticular lenses and transmit a left-eye-view and a right-eye-view to user's left and right eyes, respectively so as to separate the two views

According to the above approaches, a right-eye-view is delivered to only a right eye and a left-eye-view is delivered to only a left eye, thereby resulting in a binocular disparity that is seen when looking at an object in the real world. This binocular disparity allows a viewer to perceive the same sense of depth as in observing an object in the real world.

Approaches to creating a 3D image using eyeglasses require a special device to be worn by the viewer in addition to the use of a display device. On the other hand, approaches to creating a 3D image without glasses suffer from severe overlaps between the left-eye and right-eye views according to viewing angle or distance, thereby restricting their use.

There have been many new developments with displays that can be: folded, rolled, rubberlike, elastic, and deformed. Since such display devices allow display of different user interfaces and images according to their deformed shapes, these devices are being widely used in various applications.

### SUMMARY OF CERTAIN INVENTIVE ASPECTS

One inventive aspect relates to a foldable display for creating a three-dimensional (3D) image and a method and apparatus for controlling the foldable display.

According to another inventive aspect, there is an apparatus for controlling a display device, including: the display device including a first display panel and a second display panel disposed on the first display panel, wherein the first and second display panels are folded along a first axis; a recognizer for recognizing folding of at least one of the first and second display panels; and a display controller for controlling a display operation of the display device according to the recognized folding.

The display controller may control the display device to display a 3D image according to the recognized folding.

The display controller may control the display device to display a 3D image when the recognizer recognizes the folding and to display a 2D image when the recognizer does not recognize the folding.

The 3D image may include a left-eye view and a right-eye view that will be presented to left and right eyes of a viewer, respectively. The display controller may control the display device to separately display the left- and right-eye views.

At least a portion of the second display panel may be separated from the first display panel due to folding of the second display panel. The recognizer may recognize at least one of a separated region of the second display panel separated from the first display panel, an exposed region of the first display panel exposed due to a separation of the separated region, and a non-separated region of the second display panel not separated from the first display panel.

The apparatus may further include a display region setting unit for setting a first display region and a second display region on at least one of the exposed region and the non-separated region.

One of the exposed region and the non-separated region may be set as the first display region while the other region may be set as the second display region.

The display region setting unit may set a part of the exposed region as the first display region and the remaining part thereof as the second display region based on a position where the second display panel is folded.

The display controller may control the display device so that one of the first display region and the second display region displays a left-eye view which will be transmitted to a viewer's left eye while the other display region displays the right-eye view which will be transmitted to the viewer's right eye. The left- and right-eye views may have a binocular disparity.

The display device may further include a cover, which is disposed below the first display panel, includes a circuitry and a battery, and is made of a foldable material. The second display panel may be disposed on at least one of the cover and the first display panel.

The second display panel may include thin-film magnets disposed at a bottom thereof.

One side of the second display panel may have thin-film magnet with an N pole at the bottom thereof while the other side thereof may have a thin-film magnet 122 with an S pole at the bottom thereof. The second display panel may maintain a folded state due to the presence of the thin-film magnets.

Another inventive aspect is, a method of controlling a foldable display device including a first display panel and a second display panel disposed on the first display panel, wherein the first and second display panels are folded along a first axis, the method including recognizing folding of at least one of the first and second display panels and controlling a display operation of the foldable display device according to the recognized folding.

In the controlling of the display operation of the display device, the display device may be controlled to display a 3D image according to the recognized folding.

In the controlling of the display operation of the foldable display device, the foldable display device may be controlled to display a 3D image upon recognizing the folding and to display a 2D image upon not recognizing the folding.

The 3D image may include a left-eye view and a right-eye view that will be presented to left and right eyes of a viewer, respectively. In the controlling of the display operation of the foldable display device, the foldable display device may be controlled to separately display the left- and right-eye views.

At least a portion of the second display panel may be separated from the first display panel due to folding of the second display panel. In the recognizing of the folding of at least one of the first and second display panels, at least one of a separated region of the second display panel, an exposed region of the first display panel, and a non-separated region of the second display panel may be detected by the recognizer. The separated region may be separated from the first display panel, and the exposed region may be exposed due to a separation of the separated region, while the non-separated region is not separated from the first display panel.

The method may further include setting a first display region and a second display region on at least one of the exposed region and the non-separated region.

In the setting of the first and second display regions, one of the exposed region and the non-separated region may be set as the first display region while the other region may be set as the second display region.

In the setting of the first and second display regions, a part of the exposed region may be set as the first display region, and the remaining part thereof may be set as the second display region, based on a position where the second display panel is folded.

In the controlling of the display operation of the foldable display device, the foldable display device may be controlled so that one of the first display region and the second display region displays a left-eye view which will be transmitted to a viewer's left eye while the other display region displays the right-eye view which will be transmitted to the viewer's right eye. The left- and right-eye views may have a binocular disparity.

The display device may further include a cover which is disposed below the first display panel, includes a circuitry and a battery, and is made of a foldable material. The second display panel may be disposed on at least one of the cover and the first display panel.

According to another inventive aspect, there is a display device including: a cover including a circuitry and a battery; a first display panel disposed on the cover so as to at least a portion of the cover; and a second display panel disposed on the first display panel or the cover so as to cover the first display panel and the cover. The cover and the second display panel may be made of a foldable material.

The second display panel may include thin-film magnets disposed at a bottom thereof.

A left-eye-view and a right-eye-view may be separately displayed according to a deformation of a foldable display. Thus, the foldable display can provide a 3D image without special eyewear or compartment for separating images.

Furthermore, one of a 2D image and a 3D image may be selectively displayed according to the deformation of the foldable display.

### BRIEF DESCRIPTION OF THE DRAWINGS

FIGS. 1A and 1B are schematic diagrams of a foldable display according to one embodiment.

FIG. 2 schematically illustrates a construction of a control unit for controlling a foldable display according to one embodiment.

FIGS. 3A and 3B are diagrams for explaining control of a foldable display according to one embodiment.

FIG. 4 is a diagram for explaining control of a foldable display according to another embodiment.

FIG. 5 is a cross-sectional view taken along A-A′ of FIG. 1A according to another embodiment.

FIGS. 6A and 6B illustrate cross-sections of a foldable display according to another embodiment.

FIGS. 7A and 7B are schematic diagrams of a foldable display according to another embodiment;

FIG. 8 is a diagram for explaining control of a foldable display according to another embodiment.

FIG. 9 is a cross-sectional view taken along line B-B′ of FIG. 8.

FIG. 10 illustrates a cross-section of the foldable display of FIG. 8.

FIG. 11 is a flowchart of a method of controlling a foldable display according to one embodiment.

### DETAILED DESCRIPTION OF CERTAIN ILLUSTRATIVE EMBODIMENTS

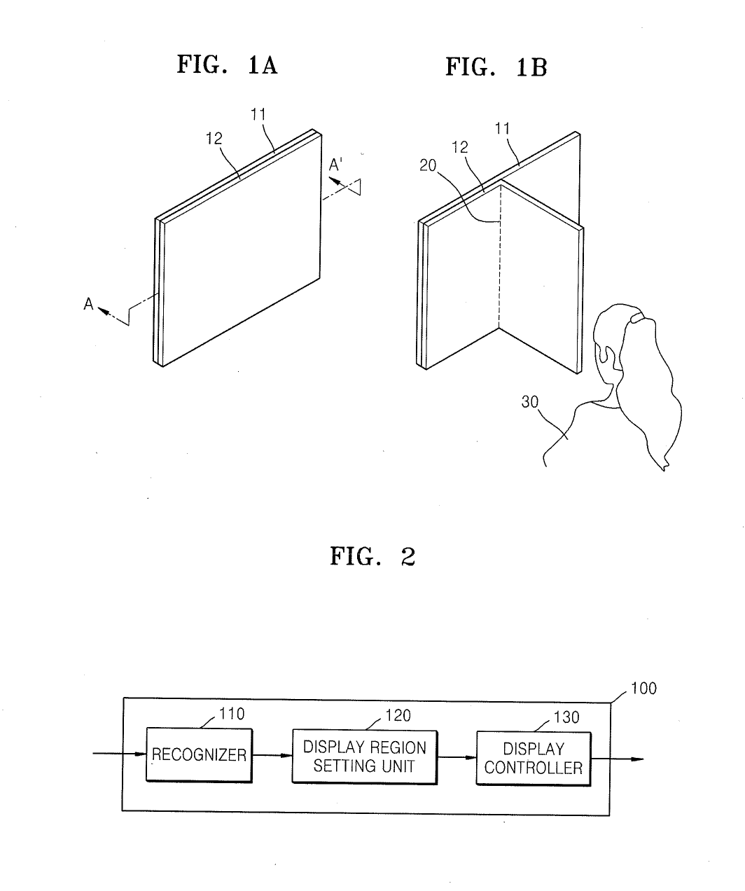

FIGS. 1A and 1B are schematic diagrams of a foldable display according to one embodiment.

FIG. 1A illustrates a foldable display in an unfolded state. Referring to FIG. 1A, the foldable display includes a first display panel 11 and a second display panel 12 disposed on the first display panel 11 wherein the first and second display panels 11 and 12 are folded along a first axis as a virtual fold line.

The display can be portable because the display can be folded and deformed. The foldable display may also display an image in a folded or unfolded state, thereby allowing various screen configurations and excellent utilization.

For this purpose, at least a part of the foldable display may be flexible. The entire foldable display may be flexible. Because the foldable display may be deformed into different shapes, it can have superior maintainability and portability.

Each of the first and second display panels 11 and 12 may include a flexible substrate made of a foldable plastic material or metal foil such as stainless steel (SUS) foil, a pixel region formed on the flexible substrate, and a passivation layer. The first and second display panels 11 and 12 may be an organic light-emitting display device or a liquid crystal display device, but are not limited thereto.

Referring to FIG. 1A, the foldable display may be a one-sided display. The first and second display panel 11 and 12 may be top- or bottom-emission organic light-emitting display panels. They may be dual-side emission organic light-emitting display panels.

FIG. 1B illustrates the foldable display in a partially folded state. Referring to FIG. 1B, the second display panel 12 may be folded along a first axis 20 which is a virtual fold line. Although FIG. 1B illustrates a foldable display with a right side of the second display panel 12 separated from the first display panel 11 due to folding of the second display panel 12. A left side of the second display panel 12 may be separated from the first display panel 11 due to folding of the second display panel 12.

Referring to FIG. 1B, a viewer 30 may see an image through a foldable display. The right side of the second display panel 12 is separated from the first display panel 11 due to the folding of the second display panel 12 this acts as a divider located between left and right eyes of the viewer 30. The presence of the compartment causes the left eye of the viewer 30 to acquire an image from the second display panel 12 on the left side of the first axis 20 and the right eye to acquire an image from the first display panel 11 on the right side of the first axis 20. In other words, the compartment may separate paths along which the respective images are displayed to the eyes of the viewer 30.

The foldable display shown in FIG. 1B displays images incident on the left and right eyes of the viewer 30 as described above, thereby enabling the viewer 30 to see a three-dimensional (3D) image.

FIG. 2 schematically illustrates a construction of a control unit 100 for controlling a foldable display according to one embodiment. As described above, the foldable display includes a first display panel (11 in FIG. 1) made of a foldable material and a second display panel (12 in FIG. 1) which is disposed on the first display panel 11 and made of a foldable material. An apparatus for controlling the foldable display includes the foldable display and the control unit 100 for controlling the display operation of the foldable display according to folding of the foldable display.

Referring to FIG. 2, the control unit 100 includes a recognizer 110, a display region setting unit 120, and a display controller 130.

The recognizer 110 recognizes the folding of at least one of the first and second display panels 11 and 12. For example, the recognizer 110 may recognize a position and a direction in which the at least one of the first and second display panels is folded.

To do so, the foldable display may include a sensor for detecting the folding of at least one of the first and second display panels 11 and 12. For example, the foldable display may include at least one angular velocity sensor disposed on the first axis 20. Alternatively, the foldable display may include a plurality of proximity sensors which are disposed on a front or rear surface thereof and detect the folding of the foldable display. In another embodiment, the foldable display recognizes the folding of at least one of the first and second display panels 11 and 20 by sensing a variation in resistance of a substrate (e.g. resistance of a folded region of a substrate) of at least one of the first and second display panel 11 and 12. In another embodiment, the foldable display may recognize its folding by using an acceleration sensor.

The display region setting unit 120 may set a display region according to the folding recognized by the recognizer 110. The display controller 130 may control a display operation of the foldable display according to the recognized folding.

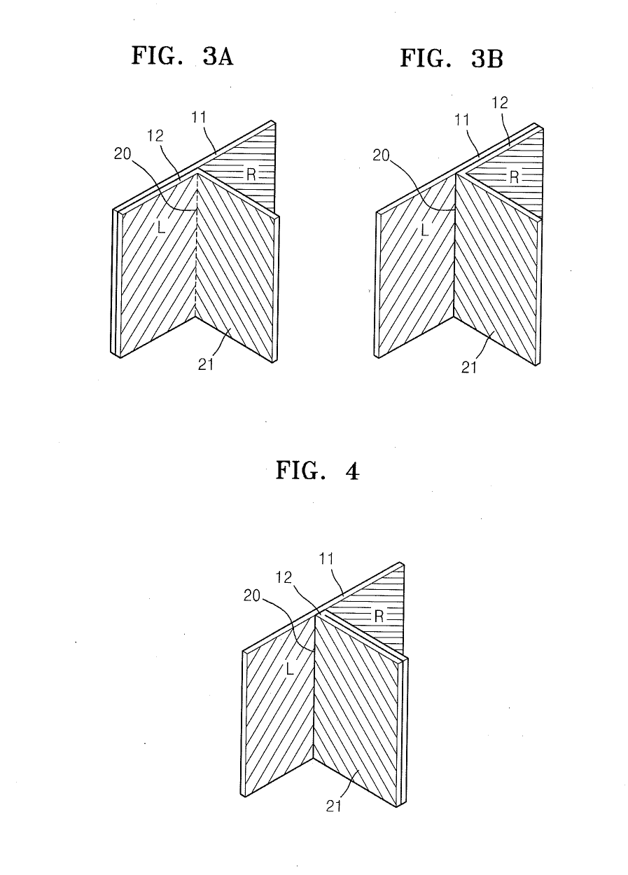

A construction of a foldable display, a method of deforming the foldable display and a method of controlling the foldable display in the control unit (100 in FIG. 2) will be described by way of embodiments illustrated in FIGS. 3 through 11.

FIGS. 3A and 3B are diagrams for explaining control of a foldable display according to one embodiment. Referring to FIGS. 3A and 3B, at least a region 21 of a second display panel 12 in the foldable display may be separated from a first display panel 11 due to the folding of the second display panel 12. When the second display panel 12 is folded, the recognizer (110 in FIG. 2) may recognize at least one of the region 21 of the second display panel 12 separated from the first display panel 11 (hereinafter referred to as a ‘separated region’), a region of the first display panel 11 exposed due to a separation of the separated region 21 (hereinafter referred to as an ‘exposed region’), and a region of the second display panel 12 not separated from the first display panel 11 (hereinafter referred to as a ‘non-separated region’).

FIG. 3A illustrates a foldable display with the second display panel 12 folded by separating a right side of the second display panel 12 from the first display panel 11. FIG. 3B illustrates the foldable display with the second display panel 12 folded by separating a left side of the second display panel 12 from the first display panel 11. In other words, the second display panel 12 may be folded in either way.

The display region setting unit 120 may set first and second display regions on at least one of the exposed region and non-separated region recognized by the recognizer 110. For example, the display region setting unit 120 may set one of the exposed region and the non-separated region detected by the recognizer 110 as the first display region and the other region as the second display region.

As shown in FIG. 3A, for example, the display region setting unit 120 may set the non-separated region of the second display panel 12 as the first display region L and the exposed region of the first display panel 11 as the second display region R.

Alternatively, as shown in FIG. 3B, the display region setting unit 120 may set the exposed region of the first display panel 11 as the first display region L and the non-separated region of the second display panel 12 as the second display region R.

The display controller 130 may control the foldable display to display a 3D image according to the folding recognized by the recognizer 110. In this case, the 3D image may include a left-eye view and a right-eye view, which will be presented to a viewer's left and right eyes, respectively. The left-eye view and the right-eye view may be separated by a binocular disparity.

The display controller 130 may also control the foldable state to separately display the left-eye view and the right-eye view. For example, the display controller 130 may control the foldable display so that one of the first display region L and the second display region R displays the left-eye view which will be delivered to the viewer's left eye while the other display region L or R displays the right-eye view which will be delivered to the viewer's right eye.

Referring to FIGS. 3A and 3B, the display controller 130 may display the left-eye view on the first display region L and the right-eye view on the second display region R. The separated region 21 acts as a compartment for separating paths along which the left- and right-eye views displayed on the first and second display regions L and R are incident to the viewer's left and right eyes, respectively.

Thus, the viewer's left eye sees the left-eye view displayed on the first display region L while the right eye sees the right-eye view displayed on the second display region R. A binocular disparity induced between the left- and right-eye views allows the viewer to perceive a sense of depth and see a 3D image in a way that he/she looks at an object in the real world.

FIG. 4 is a diagram for explaining control of a foldable display according to another embodiment. Referring to FIG. 4, a second display panel 12 may be folded by separating one and the other sides of the second display panel 12 from a first display panel 11. The second display panel 12 may be folded along a first axis 20 as a virtual fold line while a portion of the second display panel 12 at which the first axis 20 is disposed may be connected to the first display panel 11.

The recognizer (110 in FIG. 2) may recognize a separated region 21 and an exposed region. Referring to FIG. 4, the first display panel 11 may be connected to a portion corresponding to the first axis 20 of the second display panel 12, and the remaining portion of the first display panel 11 excluding the portion connected to the second display panel 12 may be separated from the second display panel 12 and then exposed. The entire exposed portion of the first display panel 11 may be recognized as the exposed region by the recognizer 110.

The display region setting unit (120 in FIG. 2) may set a part of the exposed region as a first display region and the remaining part thereof as a second display region based on a position where the second display panel 12 is folded. Referring to FIG. 4, the display region setting unit 120 divides the exposed region of the first display panel 11 into left- and right-hand regions and sets the left-hand region as the first display region L and the right-hand region as the second display region R.

The display controller (130 in FIG. 2) may control the foldable display to display left- and right-eye views on the first and second display regions L and R, respectively. In this case, the separated region 21 may act as a compartment for separating paths along which the left- and right-eye views are incident to the eyes of the viewer 30.

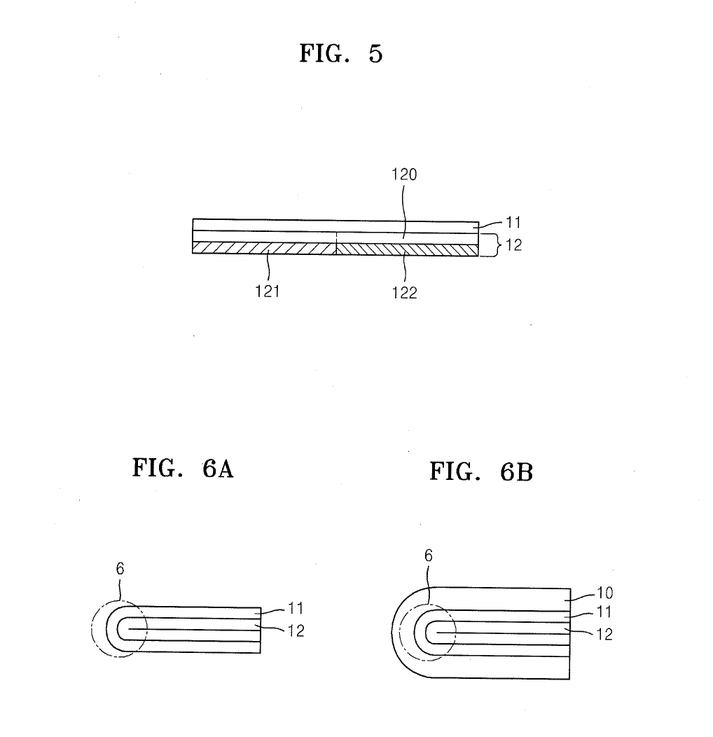

FIG. 5 is a cross-sectional view taken along A-A′ of FIG. 1A according to another embodiment. Referring to FIG. 5, a foldable display includes a first display panel 11 and a second display panel 12 disposed on the first display panel 11. In this case, the second display panel 12 has thin-film magnets 121 and 122 disposed at a bottom thereof.

For example, one side of the second display panel 12 has the thin-film magnet 121 having an N pole at the bottom thereof while the other side thereof has the thin-film magnet 122 having an S pole at the bottom thereof. Thus, when folded as shown in FIG. 4, the second display panel 12 may maintain a folded state due to attraction between the thin-film magnets 121 and 122 having N and S poles disposed at the bottom thereof, respectively.

Although the second display panel 12 includes the thin-film magnets 121 and 122 over its entire bottom surface, it is illustrated for convenience of explanation. For example, the second display panel 12 may include the thin-film magnets 121 and 122 at predetermined positions of one and the other sides thereof. The thin-film magnets 121 and 122 may be disposed at positions corresponding to each other when folded as shown in FIG. 4.

FIGS. 6A and 6B illustrate cross-sections of a foldable display according to another embodiment. Referring to FIG. 6A, both the first and second display panels 11 and 12 in the foldable display according to the present embodiment may be folded along a center thereof. The thus-deformed foldable display may be easy to carry and easy to keep.

In this case, the first and second display panels 11 and 12 may be attached to each other at a folded portion 6 thereof, and electrically connected to each other for data communication.

Referring to FIG. 6B, the foldable display according to embodiments may further include a cover 10 which is disposed below the first display panel 11, includes a circuitry and a battery, and is made of a foldable material.

Referring to FIG. 6B, the cover 10 may also be folded along the center thereof, together with the first and second display panels 11 and 12. The thus-deformed foldable display can be easy to carry and keep.

The cover 10, the first display panel 11, and the second display panel 12 may be attached to one another at a folded portion 6 thereof and electrically connected to one another for data communication. Thus, the first display panel 11, the second display panel 12, and the cover 10 can communicate data with one another.

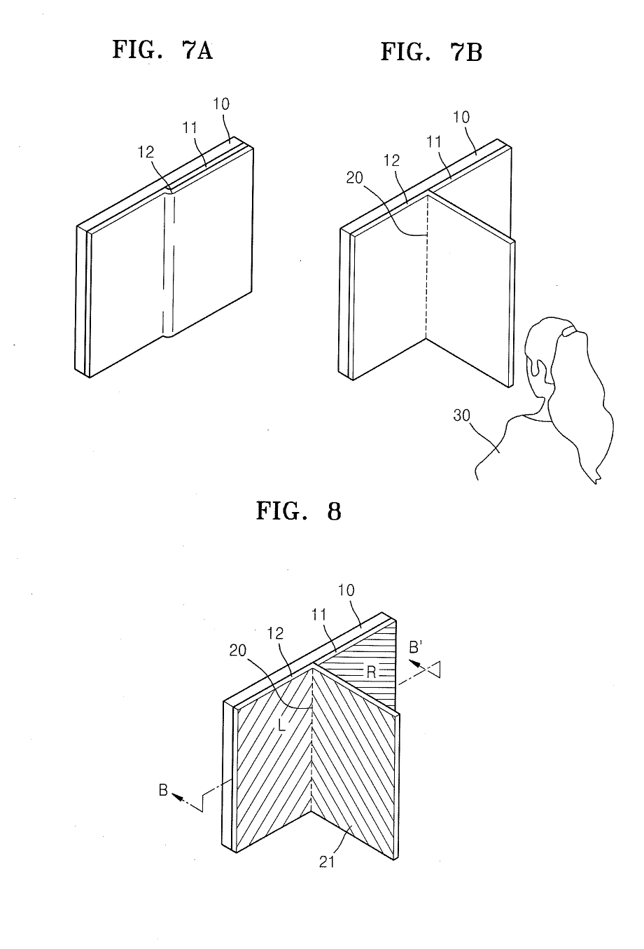

FIGS. 7A and 7B are schematic diagrams of a foldable display according to another embodiment. Referring to FIG. 7A, the foldable display includes a cover 10, a first display panel 11 disposed on the cover 10, and a second display panel 12 disposed on at least one of the cover 10 and the first display panel 11.

Referring to FIG. 7A, the first display panel 11 may be disposed on the cover 10 so as to cover only a portion of the cover 10. The second display panel 12 may be formed on the cover 10 and the first display panel 11 so as to cover the remaining uncovered portion of the cover 10 and the first display panel 11. A position at which the first display panel is disposed on the cover 10 is not limited to the embodiment illustrated in FIG. 7A.

FIG. 7B illustrates a state in which the foldable display of FIG. 7A is folded. Referring to FIG. 7B, the second display panel 12 may be folded along a first axis 20 as a virtual fold line. Although the second display panel 12 is folded by separating a right side of the second display panel 12 from the first display panel 11. For example, when the first display panel 11 is formed on the cover 10 to cover a left side of the cover 10, the second display panel 12 can be folded by separating a left side of the second display panel 12 from the first display panel 11.

Referring to FIG. 7B, a viewer 30 sees an image through a foldable display. The right side of the second display panel 12, separated from the first display panel 11 due to the folding of the second display panel 12, acts as a compartment located between left and right eyes of the viewer 30. The presence of the compartment causes the left eye of the viewer 30 to acquire an image from the second display panel 12 on the left side of the first axis 20 and the right eye to acquire an image from the first display panel 11 on the right side of the first axis 20. In other words, the compartment separates paths along which the respective images are incident to the eyeballs of the viewer 30.

According to embodiments, since the first display panel 11 is not foldable, the first display panel 11 can be made of a rigid material, and thus, it can be a general flat display panel. However, since the second display panel 12 and the cover 10 can be folded while in use, they will include a flexible material.

FIG. 8 is a diagram for explaining control of a foldable display according to another embodiment. Referring to FIG. 8, at least a portion 21 of a second display panel 12 may be separated from the first display panel 11 due to folding of the second display panel 12. The recognizer (110 in FIG. 2) may recognize at least one of the separated region 21 of the second display panel 12 separated from the first display panel 11, an exposed region of the first display panel 11 exposed due to a separation of the separated region 21, and a non-separated region of the second display panel 12 not separated from the first display panel 11.

FIG. 8 shows a configuration in which the second display panel 12 is folded by separating the right side of the second display panel 12 from the first display panel 11. There can be other configurations, for example, when the first display panel 11 is disposed on a cover 10 to cover a left side of the cover 10, the second display panel 12 may be folded by separating a left side of the second display panel 12 from the first display panel 11.

Referring to FIG. 8, the display region setting unit (120 in FIG. 2) may set the non-separated region as the first display region L and the exposed region of the first display panel 11 as the second display region R. Since the entire surface of the first display panel 11 is exposed in the embodiment shown in FIG. 8, the entire surface of the first display panel 11 may be set as the second display region R.

Referring to FIG. 8, the display controller 130 may control the foldable display to display left- and right-eye views on the first and second display regions L and R, respectively. In this case, the separated region 21 may act as a compartment for separating paths along which the left- and right-eye views are incident to left and right eyes of the viewer 30, respectively.

Thus, the viewer's left eye sees the left-eye view displayed on the first display region L while the right eye sees the right-eye view displayed on the second display region R. A binocular disparity induced between the left- and right-eye views allows the viewer to perceive a sense of distance and see a 3D image in a way that he/she looks at an object in the real world.

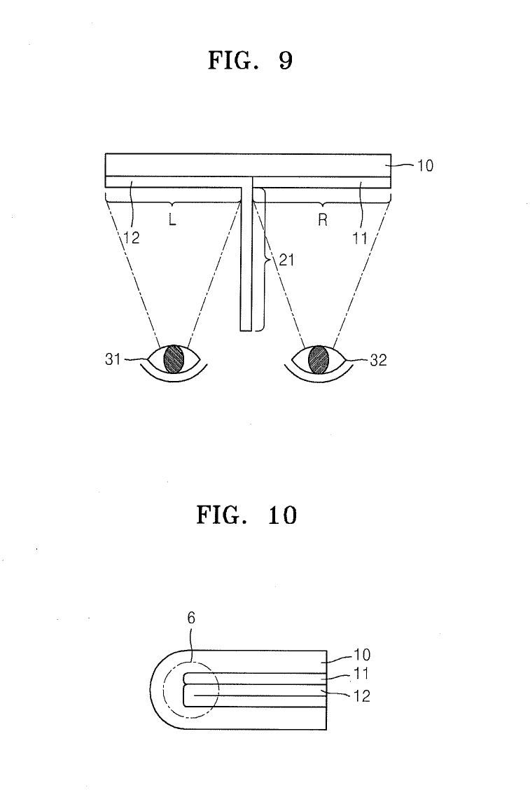

FIG. 9 is a cross-sectional view taken along line B-B′ of FIG. 8. Referring to FIG. 9, the foldable display includes a substrate 10, the first display panel 11, and the second display panel 12. As a portion of the second display panel 12 is folded, the separated region 21 may be recognized. The first display region L and the second display region R may be set on the left and right sides of the separated region 21, respectively. The first display region L and the second display region R may display left- and right-eye views, respectively. The separated region 21 may act as a compartment for separating paths along which the left- and right-eye views are incident to the viewer's left and right eyes, respectively, thereby allowing the viewer to see an image with a sense of depth.

FIG. 10 illustrates a cross-section of the foldable display of FIG. 8. Referring to FIG. 10, both the cover 10 and the second display panel 12 may be folded along a center of the foldable display. The thus-formed foldable display is easy to carry and easy to keep.

The first and second display panels 11 and 12 may be electrically connected to the cover 10 at a portion which contacts the cover 10 so as to communicate data with the cover 10. Furthermore, the first and second display panels 11 and 12 may be attached to each other at a portion 6 where the foldable display is folded and electrically connected to each other.

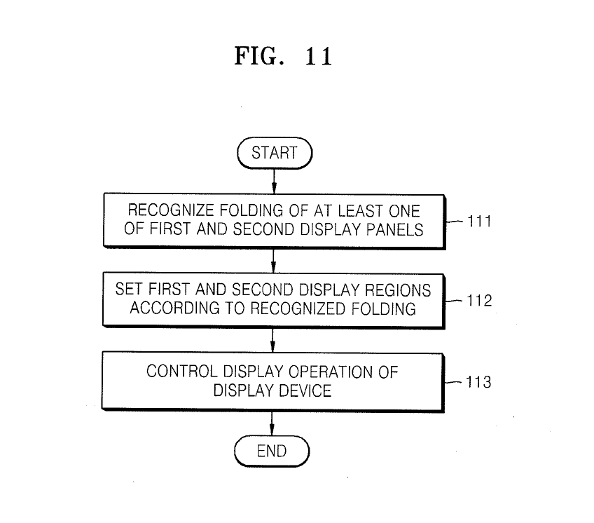

FIG. 11 is a flowchart of a method of controlling a foldable display according to one embodiment. The foldable display includes a first display panel made of a foldable material and a second display panel which is formed on the first display panel and made of a foldable material. In another embodiment, the foldable display may further include a cover which is formed below the first display panel, includes a circuitry and a battery, and is made of a foldable material. The second display panel can be formed on at least one of the cover and the first display panel.

Referring to FIG. 11, the recognizer (110 in FIG. 2) recognizes the folding of at least one of the first and second display panels (S111). More specifically, as at least a portion of the second display panel is separated from the first display panel due to the folding of the second display panel, the recognizer 110 can recognize at least one of a separated region of the second display panel separated from the first display panel, an exposed region of the first display panel exposed due to a separation of the separated region, and a non-separated region of the second display panel not separated from the first display panel.

The display region setting unit (120 in FIG. 2) sets a first display region and a second display region according to the folding recognized in operation S111 (S112). In one embodiment, the display region setting unit 120 may set the first display region and the second display region on at least one of the exposed region and the non-separated region recognized in operation 111. For example, the display region setting unit 120 may set at least one of the exposed region and the non-separated region recognized in operation 111 as the first display region and the other one as the second display region.

In another embodiment, in operation 112, the display region setting unit 120 may set a part of the exposed region as a first display region and the remaining part thereof as a second display region based on a position where the second display, panel is folded.

The display controller (130 in FIG. 2) controls the display operation of the foldable display device based on the first and second display regions set in operation 112 (S113). In one embodiment, the display controller 130 controls the foldable display to display a 3D image. For this purpose, the display controller 130 controls the foldable display to display a left-eye view on one of the first and second display regions and a right-eye view on the other region.

According to another embodiment, in operation 113, the display controller 130 may control the foldable display to display a 3D image when the folding is recognized in operation 111 or to display a 2D image when the folding is not recognized in operation 111.

In order to display a 3D image, in operation 113, the display controller 130 may the foldable display to separately display the left- and right-eye views.

According to one or more embodiments, the display controller 130 may control the foldable display to display a 3D image when the recognizer 110 detects the folding of at least one of the first and second display panels or to display a 2D when the recognizer 110 does not detect the folding thereof.

Furthermore, the display controller 130 may receive a user's input in order to change the display of a 2D or 3D image. To do so, the display controller 130 may control the foldable display to display a user interface (UI)/user experience design (UX) screen for receiving a user's input.

According to one or more embodiments of the present invention, a left-eye view and a right-eye view may be obtained through a stereoscopic photography technique for photographing an object with two cameras which are separated from each other by a distance of about 65 mm so as to create a stereoscopic effect. A 3D image containing the left- and right-eye views obtained through the stereoscopic photography technique may be transmitted in real time to a foldable display over broadcasting radio waves, broadcasting cables, and the Internet, or may be stored in a storage medium connected to the foldable display and then output to the foldable display during playback.

According to one or more aspects, a left-eye-view and a right-eye-view may be separately displayed according to a deformation of a foldable display. Thus, the foldable display can provide a 3D image without a special eyewear or compartment for separating images. Furthermore, one of a 2D image and a 3D image may be selectively displayed according to the deformation of the foldable display.

While the terms such as “first” and “second” may be used to describe various components, such components are not limited to the above terms. The terms are used only to distinguish one component from another.

The terms used in the present application are merely used to describe an embodiment, and are not intended to limit the present invention. Use of singular forms includes plural references as well unless expressly specified otherwise. The terms “comprising”, “including”, and “having” specify the presence of stated features, numbers, steps, operations, elements, components, and/or a combination thereof but do not preclude the presence or addition of one or more other features, numbers, steps, operations, elements, components, and/or a combination thereof. Expressions such as “at least one of,” when preceding a list of elements, modify the entire list of elements and do not modify the individual elements of the list.

While the present invention has been particularly shown and described with reference to exemplary embodiments thereof, it will be understood by those of ordinary skill in the art that various changes in form and details may be made therein without departing from the spirit and scope of the present invention as defined by the following claims. Although not described herein, all differences within the scope of the appended claims and their equivalents will be construed as being included in the present invention.

What is claimed is:

1. An apparatus for controlling a display device, the apparatus comprising:
the display device including a first display panel and a second display panel formed on the first display panel, wherein the first and second display panels are folded along a first axis;
a recognizer for recognizing a folding configuration of at least one of the first and second display panels; and
a display controller for controlling the display operation of the display device according to the recognized folding configuration.

2. The apparatus of claim 1, wherein the display controller controls the display device to display a three-dimensional (3D) image according to the recognized folding configuration.

3. The apparatus of claim 2, wherein the display controller controls the display device to display a 3D image when the recognizer recognizes the folding configuration of the display device and to display a 2D image when the recognizer does not recognize the folding configuration of the display device.

4. The apparatus of claim 2, wherein the 3D image includes a left-eye view and a right-eye view that will be presented to left and right eyes of a viewer, respectively, and
wherein the display controller controls the display device to separately display the left- and right-eye views.

5. The apparatus of claim 1, wherein at least a portion of the second display panel is separated from the first display panel due to folding of the second display panel, and
wherein the recognizer recognizes at least one of a separated region of the second display panel separated from the first display panel, an exposed region of the first display panel exposed due to a separation of the separated region, and a non-separated region of the second display panel not separated from the first display panel.

6. The apparatus of claim 5, further comprising a display region setting unit for setting a first display region and a second display region on at least one of the exposed region and the non-separated region.

7. The apparatus of claim 6, wherein one of the exposed region and the non-separated region is set as the first display region while the other region is set as the second display region.

8. The apparatus of claim 6, wherein the display region setting unit sets a part of the exposed region as the first display region and the remaining part thereof as the second display region based on a position where the second display panel is folded.

9. The apparatus of claim 6, wherein the display controller controls the display device so that one of the first display region and the second display region displays a left-eye view which will be perceived by a viewer's left eye while the other display region displays the right-eye view which will be perceived by the viewer's right eye, and
wherein the left- and right-eye views have a binocular disparity.

10. The apparatus of claim 1, wherein the display device further includes a cover which is formed below the first display panel, includes circuitry and a battery, and is made of a foldable material, and
wherein the second display panel is formed on at least one of the cover and the first display panel.

11. The apparatus of claim 1, wherein the second display panel includes thin-film magnets disposed at the bottom thereof.

12. The apparatus of claim 11, wherein one side of the second display panel has a thin-film magnet with an N pole at the bottom thereof while the other side thereof has a thin-film magnet 1 with an S pole at the bottom thereof, and
wherein the second display panel maintains a folded state due to the presence of the thin-film magnets

13. A method of controlling a display device including a first display panel and a second display panel disposed on the first display panel, wherein the first and second display panels are folded along a first axis, the method comprising
recognizing the folding configuration of at least one of the first and second display panels and
controlling the display operation of the display device according to the recognized folding configuration.

14. The method of claim 13, wherein at least a portion of the second display panel is separated from the first display panel due to folding of the second display panel, and
wherein in the recognizing of the folding configuration of at least one of the first and second display panels, at least one of a separated region of the second display panel, an exposed region of the first display panel, and a non-separated region of the second display panel is recognized, wherein the separated region is separated from the first display panel, the exposed region is exposed due to a separation of the separated region, and the non-separated region is not separated from the first display panel.

15. The method of claim 14, further comprising setting a first display region and a second display region on at least one of the exposed region and the non-separated region.

16. The method of claim 15, wherein in the setting of the first and second display regions, one of the exposed region and the non-separated region is set as the first display region while the other region is set as the second display region.

17. The method of claim 15, wherein in the setting of the first and second display regions, a part of the exposed region is set as the first display region, and the remaining part thereof is set as the second display region, based on a position where the second display panel is folded.

18. The method of claim 15, wherein in the controlling of the display operation of the display device, the display device is controlled so that one of the first display region and the second display region displays a left-eye view which will be presented to a viewer's left eye while the other display region displays the right-eye view which will be presented to the viewer's right eye, and
wherein the left- and right-eye views have a binocular disparity.

19. The method of claim 13, wherein the display device further includes a cover which is formed below the first display panel, includes circuitry and a battery, and is made of a foldable material, and
wherein the second display panel is formed on at least one of the cover and the first display panel.

20. A display device comprising:
a cover including a circuitry and a battery;
a first display panel formed on the cover so as to at least cover a portion of the cover; and
a second display panel formed on the first display panel or the cover so as to cover the first display panel and the cover,
wherein the cover and the second display panel are made of a foldable material.

21. The display device of claim 20, wherein the second display panel includes a plurality of thin-film magnets disposed at a bottom thereof.
